(19) United States
(12) Patent Application Publication
(10) Pub. No.: US 2016/0168021 A1
(43) Pub. Date: Jun. 16, 2016

(54) SUPERHYDROPHILIC COATINGS

(71) Applicant: AGENCY FOR SCIENCE, TECHNOLOGY AND RESEARCH, Connexis, Singapore (SG)

(72) Inventors: Gregory Kia Liang Goh, Singapore (SG); Hong Quang Le, Singapore (SG)

(21) Appl. No.: 14/908,220

(22) PCT Filed: Jul. 29, 2014
(86) PCT No.: PCT/SG2014/000354

§ 371 Date: Jan. 28, 2016

(30) Foreign Application Priority Data
Jul. 29, 2013 (SG) 201305771-6

(51) Int. Cl. C03C 17/25; C09D 1/00

(52) U.S. Cl. CPC C03C 17/25; C09D 1/00; C03C 2217/213; C03C 2217/42; C03C 2217/75

(57) ABSTRACT

Method for preparing a superhydrophilic coating consisting essentially of silicon oxide is provided. The method includes providing an aqueous mixture comprising a fluorine-containing silicon complex and a fluorine scavenger; and contacting a substrate with the aqueous mixture at a temperature of less than about 100° C. to obtain said superhydrophilic coating on the substrate. Superhydrophilic coating consisting essentially of silicon dioxide islands with each island having a size in the range of about 10 nm to about 50 nm, and use of the superhydrophilic coating in various applications, such as lens, goggles, anti-fouling coatings, self-cleaning surfaces, mirrors, windshields, windows, primer layer for surfaces, and covers for cookware, are also provided.

### CROSS-REFERENCE TO RELATED APPLICATION

This application claims the benefit of priority of Singapore patent application No. 201305771-6 filed on 29 Jul. 2013, the content of which is incorporated herein by reference in its entirety for all purposes.

### TECHNICAL FIELD

The invention relates to superhydrophilic coatings.

### BACKGROUND

Wettability of a solid surface is important for various commercial applications. Studies of surface modification to obtain superhydrophobic surfaces having water droplet contact angle greater than 150°, or superhydrophilic surfaces having water droplet contact angle smaller than 10°, have attracted great attention.

Currently, surfaces have been rendered superhydrophobic to impart self-cleaning properties on the surfaces. Unfortunately, such coatings, which are generally based on organic compounds; are not durable and most have to be re-applied regularly.

Superhydrophilic surfaces, on the other hand, may be obtained using photochemically active materials such as titanium dioxide (TiO₂), which become superhydrophilic upon illumination of UV light. These super-hydrophilic films induced by photocatalytic activity, however, lose their superhydrophilicity a few minutes to hours after removal of the UV irradiation, or after storing in the dark. Although work has been carried out to address this, for example, by forming composite systems such as multilayer assembly of TiO₂ nanoparticles and polyethylene glycol, it remains a challenge to sustain wetting behavior of TiO₂. Furthermore, the TiO₂ coats may only be applied on surfaces at temperatures above 600° C. This limits application of the TiO₂ coats to only materials that are able to withstand the high temperature.

In view of the above, there remains a need for improved superhydrophilic coatings and method of preparing the superhydrophilic coatings that overcome or at least alleviate one or more of the above-mentioned problems.

### SUMMARY

In a first aspect, the invention refers to a method for preparing a superhydrophilic coating consisting essentially of silicon oxide. The method comprises
a) providing an aqueous mixture comprising a fluorine-containing silicon complex and a fluorine scavenger; and
b) contacting a substrate with the aqueous mixture at a temperature of less than about 100° C. to obtain said superhydrophilic coating on the substrate.

In a second aspect, the invention refers to a superhydrophilic coating consisting essentially of silicon oxide prepared by a method according to the first aspect.

In a third aspect, the invention refers to a superhydrophilic coating consisting essentially of silicon dioxide islands with each island having a size in the range of about 10 nm to about 50 nm.

In a fourth aspect, the invention refers to use of a superhydrophilic coating prepared by a method according to the first aspect or a superhydrophilic coating according to the third aspect in lens, goggles, anti-fouling coatings, self-cleaning surfaces, mirrors, windshields, windows, primer layer for surfaces, and covers for cookware.

### BRIEF DESCRIPTION OF THE DRAWINGS

The invention will be better understood with reference to the detailed description when considered in conjunction with the non-limiting examples and the accompanying drawings, in which:

FIG. 1 is a scanning electron microscopy (SEM) result showing surface morphology of film grown on glass substrate at 50° C.

FIG. 2 is a graph showing ultraviolet-visible spectroscopy (UV/VIS) transmission spectra of a glass substrate and a film grown on glass.

FIG. 3 is a graph showing reflectance spectra of glass substrate with and without silicon dioxide (SiO₂) coating in the visible range.

FIG. 4A is a graph showing X-ray photoelectron spectroscopy (XPS) spectra of SiO₂ film for Si 2p. FIG. 4B is a graph showing XPS spectra of SiO₂ film for O 1 s.

FIG. 5A is a graph showing Time-of-Flight Secondary Ion Mass Spectrometry (TOF-SIMS) results of SiO₂ film grown on glass substrate. FIG. 5B is a graph showing TOF-SIMS results of bare glass substrate.

FIG. 6A to C depict (A) dispensing of 2 μL water droplet during the contact angle measurement, on (B) uncoated glass; and (C) glass coated with SiO₂ film. Spreading of the 2 μL water droplet during the contact angle measurement on glass coated with SiO₂ film demonstrates superhydrophilic behavior of the SiO₂ film.

FIG. 7A to C show contact angle measurements for the SiO₂ film after increasing periods of time for (A) 1 week; (B) 1 month; and (C) more than 2 months.

FIG. 8 is a graph showing variation of contact angle with time for SiO₂ film grown using liquid phase deposition (LPD).

FIGS. 9A and B show a glass slide partially covered with SiO₂ film. FIG. 9A depicts a water spray test on glass slide with and without SiO₂ film coating. FIG. 9B shows contact angle of water droplets on glass slide with and without SiO₂ film coating.

FIG. 10A to C show effects of water cleaning on contact angle of water droplet on SiO₂ film, where (A) depicts contact angle of water droplet after being dispensed on a SiO₂ film that has been deposited two months prior; (B) depicts contact angle of water droplet on the SiO₂ film following cleaning of the film with water; and (C) depicts contact angle of water droplet on the SiO₂ film following ultrasonic cleaning of the film with water.

FIGS. 11A and B show effects of cleaning on contact angle of water droplet on SiO₂ film, using (A) detergent, and (B) Piranha solution.

FIG. 12 is a cross-section SEM of the SiO₂ film grown on glass.

### DETAILED DESCRIPTION

In a first aspect, the invention refers to a method for preparing a superhydrophilic coating consisting essentially of silicon oxide. As used herein, the term “superhydrohilic” refers to an attribute of a substrate whereby contact angle between a water droplet and a surface of the substrate is smaller than about 10°. For example, contact angle of the superhydrophilic coating disclosed herein may be smaller than 10°, such as smaller than 8°, smaller than 6°, or smaller than 5°.

Advantageously, the superhydrophilic silicon oxide coatings disclosed herein may be obtained using a liquid phase deposition process at low growth temperatures of less than 100° C. This translates into versatility of the preparation method since the superhydrophilic silicon oxide coatings may be formed on any substrate, including heat sensitive surfaces such as polymeric films, plastic and organic substrates or surfaces. Further, methods to prepare the silicon oxide coatings are simple and may be easily scaled up to large area substrates for batch processing and low cost manufacturing. As photocatalytic activation or UV illumination is not required to activate superhydrophilicity of the coatings, this renders the superhydrophilic coatings suitable for night time and low-light, indoor use.

The superhydrophilic coatings prepared using a method disclosed herein consists essentially of silicon oxide. By the term “consists essentially”, this means that the coating may contain trace amounts of other substances, which may arise, for example, from the preparation process. The trace amounts of other substances may be present in an amount of less than 5 atomic %, such as less than 2 atomic %, preferably less than 1 atomic %, even more preferably less than 0.5 atomic %. In specific embodiments, the superhydrophilic coatings prepared using a method disclosed herein consists of silicon oxide.

Generally, the silicon oxide is in the form of silicon dioxide. In various embodiments, the silicon oxide consists of silicon dioxide (SiO₂). Advantageously, silicon dioxide possesses excellent chemical stability and good optical transmittance with low refractive index, which renders its suitability in various applications, such as in electronic devices as a passivating layer, and as anti-reflective coatings for display.

The method comprises providing an aqueous mixture comprising a fluorine-containing silicon complex and a fluorine scavenger. In various embodiments, the aqueous mixture consists essentially or consists of a fluorine-containing silicon complex and a fluorine scavenger.

In various embodiments, the fluorine-containing silicon complex has general formula (I):

A₂SiF₆ (I)

wherein A is selected from the group consisting of hydrogen, alkali metal, ammonium group, and coordinated water. For example, A may be an alkali metal such as lithium, sodium, potassium, rubidium, and cesium. In some embodiments, A is an ammonium group.

In various embodiments, the fluorine-containing silicon complex is selected from the group consisting of hexafluorosilicic acid, ammonium hexafluorosilicate, sodium fluorosilicate, potassium fluorosilicate, and mixtures thereof. In specific embodiments, the fluorine-containing silicon complex comprises or consists of ammonium hexafluorosilicate ((NH₄)₂SiF₆).

In various embodiments, the fluorine-containing silicon complex may be provided by mixing SiO₂ in various forms, such as powder, gel and/or film, with NH₄F or HF. In some embodiments, silica particles, powder and/or gel are added to the aqueous mixture to saturate the aqueous mixture.

Concentration of fluorine-containing silicon complex in the aqueous mixture may be in the range of about 0.02 M to about 0.1 M. For example, concentration of fluorine-containing silicon complex in the aqueous mixture may be in the range of about 0.05 M to about 0.1 M, about 0.07 M to about 0.1 M, about 0.08 M to about 0.1 M, about 0.02 M to about 0.08 M, about 0.02 M to about 0.06 M, about 0.02 M to about 0.04 M, about 0.02 M, about 0.05 M, about 0.07 M, or about 0.1 M. In specific embodiments wherein the fluorine-containing silicon complex is (NH₄)₂SiF₆, concentration of (NH₄)₂SiF₆ in the aqueous mixture may be about 0.1 M.

The term “fluorine scavenger” refers to a compound that is capable of capturing fluoride ions in the aqueous mixture comprising the fluorine-containing silicon complex to precipitate silicon oxide. By providing an aqueous mixture comprising a fluorine-containing silicon complex and a fluorine scavenger, and contacting a substrate with the aqueous mixture, a superhydrophilic coating consisting essentially of silicon oxide may be precipitated or deposited on the substrate.

The fluorine scavenger may be selected from the group consisting of boric acid, alkali metal borate, ammonium borate, boron anhydride, boron monoxide, aluminum chloride, sodium hydroxide, aqueous ammonia, metallic aluminum, aluminum oxide, and combinations thereof. In various embodiments, the fluorine scavenger comprises or consists of boric acid.

Concentration of fluorine scavenger in the aqueous mixture may be in the range of about 0.06 M to about 0.3 M. For example, concentration of fluorine scavenger in the aqueous mixture may be in the range of about 0.08 M to about 0.3 M, about 0.1 M to about 0.3 M, about 0.15 M to about 0.3 M, about 0.2 M to about 0.3 M, about 0.25 M to about 0.3 M, about 0.06 M to about 0.25 M, about 0.06 M to about 0.2 M, about 0.06 M to about 0.15 M, about 0.06 M to about 0.1 M, about 0.06 M, about 0.15 M, about 0.2 M, or about 0.3 M. In embodiments wherein the fluorine scavenger is boric acid, concentration of boric acid in the aqueous mixture may be about 0.3 M.

In various embodiments, providing an aqueous mixture comprising a fluorine-containing silicon complex and a fluorine scavenger may comprise dissolving the respective fluorine-containing silicon complex and fluorine scavenger in separate aqueous solutions, before mixing the respective aqueous solutions to form the aqueous mixture. The mixing may be carried out using any suitable method, such as stirring, shaking, blending, or vortexing. The mixing may be carried out to mix the fluorine-containing silicon complex and the fluorine scavenger in such a way that the aqueous mixture is at least substantially homogeneous.

The method includes contacting a substrate with the aqueous mixture at a temperature of less than about 100° C. to obtain said superhydrophilic coating on the substrate.

The substrate may be of any suitable material, such as glass, metals, ceramics, organic polymer materials, plastics, semiconductors, to name only a few. Further, composites of these materials may also be used as the substrate. In specific embodiments, the substrate is a glass substrate. Shape and structure of the substrate may be arbitrarily selected, and is not limited to a planar surface. For example, the substrate may have a non-planar shape, or be in the form of a product, or a building having a surface onto which the superhydrophilic coating is to be applied.

Contacting a substrate with the aqueous mixture may be carried out by immersing the substrate in the aqueous mixture. By immersing the substrate in the aqueous mixture, this provides a surface onto which the superhydrophilic coating may be formed. The superhydrophilic silicon oxide coating may be precipitated on at least a portion of the substrate that is in contact with the aqueous mixture. In various embodiments, the superhydrophilic silicon oxide coating is precipitated on substantially all of the substrate that is in contact with the aqueous mixture.

Rate of formation of silicon oxide may be controlled by concentration of and ratio of fluorine-containing silicon complex to fluorine scavenger, pH, and temperature, for example.

Referring to the first equation in Example 1 disclosed herein, by Le Chatelier's principle, a higher concentration of fluorine-containing silicon complex in the form of [SiF₆]²⁻ on the left side of the equation results in a faster forward reaction, as this drives the equation to the right. By the same principle, lowering concentration of HF present on the right side of the equation, for example, by increasing concentration of fluorine scavenger such as H₃BO₃, drives the equation to the left, resulting in faster formation of SiO₂.

pH, on the other hand, affects solubility of SiO₂. By setting pH of the aqueous mixture at a value where SiO₂ is more soluble, there is lower extent of solid SiO₂ formation. Conversely, when pH of the aqueous mixture is set at a value where SiO₂ is less soluble, higher extent of solid SiO₂ formation may result.

Apart from pH, temperature may also affect solubility of SiO₂. At the same time, it may also increase rate at which the chemical reactions take place.

As mentioned above, use of low growth temperatures of less than 100° C. means that silicon oxide films may be formed on polymeric films such as plastic and organic substrates/surfaces. In various embodiments, contacting a substrate with the aqueous mixture is carried out at a temperature in the range of about 50° C. to about 80° C., such as about 60° C. to about 80° C., about 70° C. to about 80° C., about 50° C. to about 70° C., about 50° C. to about 60° C., about 60° C. to about 70° C., about 50° C., about 60° C., about 70° C., or about 80° C. In specific embodiments, contacting a substrate with the aqueous mixture is carried out at a temperature of less than 80° C. to obtain a highly transparent coating.

Contacting a substrate with the aqueous mixture may be carried out for any suitable time period that is sufficient to obtain the superhydrophilic coating. The time period may depend on the fluorine-containing silicon complex used, as well as temperature at which the substrate is contacted with the aqueous mixture. If lower temperatures are used, for example, a longer contacting time to grow or to form the superhydrophilic coating may be required. By controlling the contacting time, thickness of superhydrophilic coating that is formed on the substrate may be controlled.

In various embodiments, contacting a substrate with the aqueous mixture is carried out for a time period in the range of about 2 hours to about 72 hours, such as about 6 hours to about 72 hours, such as about 12 hours to about 72 hours, about 24 hours to about 72 hours, about 36 hours to about 72 hours, about 48 hours to about 72 hours, about 60 hours to about 72 hours, about 2 hours to about 60 hours, about 2 hours to about 48 hours, about 2 hours to about 36 hours, about 2 hours to about 24 hours, about 2 hours to about 12 hours, about 12 hours to about 60 hours, about 12 hours to about 48 hours, about 12 hours to about 24 hours, about 3 hours to about 12 hours, or about 12 hours to about 24 hours.

In various embodiments, the superhydrophilic silicon oxide coating thus obtained has a substantially uniform thickness. Different thickness of the superhydrophilic silicon oxide coating may be obtained by controlling contact time of the substrate with the aqueous mixture. Generally, a longer contact time results in a thicker coating.

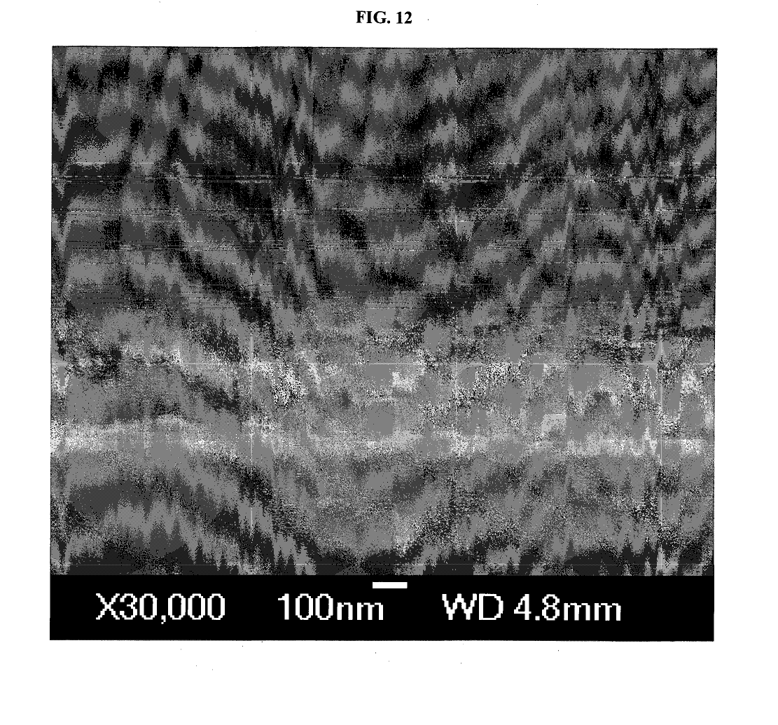

For example, thickness of the superhydrophilic silicon oxide coating may be in the range of about 100 nm to about 600 nm, such as about 150 nm to about 600 nm, about 200 nm to about 600 nm, about 300 nm to about 600 nm, about 400 nm to about 600 nm, about 500 nm to about 600 nm, about 100 nm to about 500 nm, about 100 nm to about 400 nm, about 100 nm to about 300 nm, about 100 nm to about 200 nm, about 200 nm to about 400 nm, about 250 nm to about 450 nm, or about 300 nm to about 400 nm. In the embodiment shown in FIG. 12, for example, thickness of the superhydrophilic silicon oxide coating is about 360 nm.

As mentioned above, UV excitation is not required to activate superhydrophilicity of the superhydrophilic coating. This distinguishes from state of the art methods for preparing superhydrophilic coatings containing titanium oxide where photocatalytic activation or UV excitation is required. Removal of requirements for UV excitation translates into possible applications of the superhydrophilic coatings disclosed herein for night time and indoor use.

The superhydrophilic coating prepared by a method disclosed herein may consist essentially of silicon dioxide islands. As used herein, the term “island” refers to a distinct area of a layer having a defined geometric shape that is protruding from the layer. In various embodiments, the superhydrophilic coating is made up of silicon dioxide islands capable of coalescing to form a continuous film.

The islands of silicon dioxide may each have a size in the range of about 10 nm to about 50 nm. For example, each silicon dioxide island may have a size in the range of about 20 nm to about 50 nm, about 30 nm to about 50 nm, about 40 nm to about 50 nm, about 10 nm to about 40 nm, about 10 nm to about 30 nm, about 10 nm to about 20 nm, or about 20 nm to about 40 nm. As the islands may not be regular in shape and/or be of the same shape, the term “size” as used herein refers to the maximal dimension of the islands. In various embodiments, the silicon dioxide islands are essentially monodisperse, whereby the term “monodisperse” refers to the islands of at least substantially the same size.

Superhydrophilicity of the coating disclosed herein may be due to porous nature of the film. In various embodiments, the superhydrophilic coating is mesoporous. According to IUPAC definition, mesopores have a size of between about 2 nm to about 50 nm. The mesopores may be defined by the silicon dioxide islands, and be present in the form of spacing between the islands. Advantageously, the superhydrophilic coating is highly transparent and superhydrophilic as-grown, meaning that post growth heat treatment is not required.

The superhydrophilic coating may exhibit a transmittance of at least 85% in the wavelength region from 350 nm to 750 nm. The term “transmittance” as used herein refers to intensity of radiation transmitted through a material over that of the incident radiation, and which is expressed as a percentage. The wavelength region from 350 nm to 750 nm corresponds to visible light range of the electromagnetic spectrum. In various embodiments, the coating exhibits a transmittance of at least 85%, at least 87%, or at least 90% in the wavelength region from 350 nm to 750 nm.

In further aspects, the invention refers to a superhydrophilic coating consisting essentially of silicon oxide prepared by a method according to the first aspect, and to a superhydrophilic coating consisting essentially of silicon dioxide islands with each island having a size in the range of about 10 nm to about 50 nm.

As mentioned above, the superhydrophilic coating may be mesoporous. The superhydrophilic coating may exhibit a transmittance of at least 85% in the wavelength region from 350 nm to 750 nm.

In a fourth aspect, the invention refers to use of a superhydrophilic coating prepared by a method according to the first aspect or a superhydrophilic coating according to the third aspect in buildings, lens, goggles, anti-fouling coatings, self-cleaning surfaces, mirrors, windshields, windows, primer layer for surfaces, and covers for cookware.

In various embodiments, the superhydrophilic coating is able to attract water instead of repelling it. This creates a layer of water that prevents fogging on glass or plastic surfaces, and keeps surfaces cleaner for a longer period of time. Coating building exteriors with the superhydrophilic coating, for example, allows for self-cleaning during rain. Advantageously, due to its superhydrophilic nature, the coatings create an additional uniform water layer to produce a better view as opposed to water-repelling technologies that form water droplets which impair vision. This renders the superhydrophilic coatings disclosed herein particularly suitable for applying on surfaces of mirrors, windshields and building windows, which require high transmittance in the visible range.

As another example, superhydrophilic coatings disclosed herein may be applied on surfaces to function as a primer layer, to help improve bond strength of subsequent layers, such as glue, coated thereon. The primer layer comprising the superhydrophilic coating may also be used to improve uniformity of the layers coated thereon.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

As used herein, the term “and/or” includes any and all combinations of one or more of the associated listed items. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

Herein disclosed, the liquid phase deposition method was used to synthesize uniform, transparent SiO₂ films, grown on glass substrate at low temperature. The nanoporous SiO₂ films performed the superhydrophilicity and antifogging property in the absence of UV light irradiation.

There are various techniques of growing SiO₂ film, such as thermal oxidation, chemical vapor deposition, radio frequency reactive ion sputtering, spin on glass, liquid phase deposition (LPD). The solution chemistry deposition routes namely sol-gel and liquid phase deposition (LPD) may offer attractive alternatives. However, the first technique requires post deposition annealing and complex process to achieve SiO₂ formation. The LPD SiO₂ has also some advantages over other methods, i.e. low growth temperatures (T<100° C.), no necessity for special equipment or controlled environment e.g. vacuum system. Therefore, LPD is considered to be a versatile technique for preparing SiO₂ films on various substrates (especially those that cannot survive high temperatures).

The LPD process attracts increasing interest due to the inherent simplicity and lower cost associated with such techniques. The film deposition can be completed in a plastic/glass beaker to deposit SiO₂ films over a large area, conformably on complex shapes and porous substrates. No complex equipment is required in the process and the deposition can be completed at low temperate (less than 100° C. in present case). Unlike the sol-gel process, annealing at high-temperature is avoided in present route. Thus, LPD may be engaged to prepare SiO₂ films on various substrates which is temperature sensitive and cannot bear high temperature process.

Using this method, crystalline metal oxide films may be obtained directly from aqueous solutions at low temperatures (25° C. to 100° C.). It is based on the slow hydrolysis of metal fluorine complex [MFₙ]^{m-n} with boric acid as the common fluorine scavenger. This technique produces oxide films with good uniformity over large areas by immersing targeted substrates in a supersaturated chemical solution at low temperature.

### Example 1

### Methodology

The formation of crystalline SiO₂ from the aqueous precursors via a chemical equilibrium reaction between a metal fluoro-complex and a metal oxide in aqueous solution is as shown in the following reaction:

[SiF₆]²⁻+nH₂0→[SiF₆₋ₙ(OH)ₙ]²⁻+nHF

H₃BO₃+4HF→HBF₄+3H₂0

The fluoride ligand offers a slower and more controllable hydrolysis via control of the boric acid concentration as it acts as a F⁻ scavenger.

A solution containing 0.02 M to 0.1 M ammonium hexafluorosilicate, (NH₄)₂SiF₆, and 0.06 M to 0.3 M boric acid was prepared by mixing solutions of (NH₄)₂SiF₆ and boric acid that had been separately prepared by dissolving the respective powders in water. Firstly, a glass substrate was cleaned by immersing in a piranha solution (volume ratio 3H₂SO₄:1 H₂O₂) for 15 minutes at room temperature. Then, it was cleaned with DI water, blown dry and suspended face down in the Teflon liner with the solution and placed in a convection oven at 50° C. to 80° C. for 12 hrs to 24 hrs.

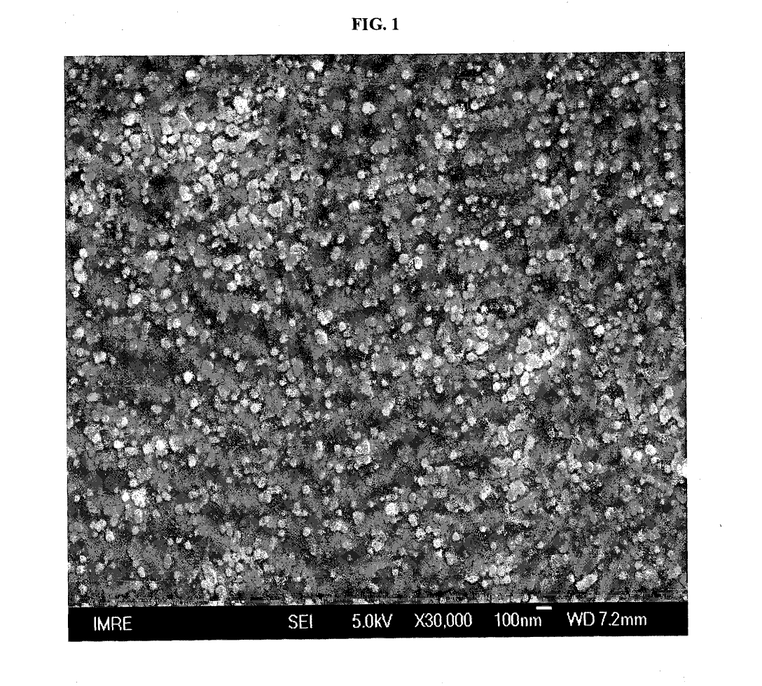

FIG. 1 shows the surface morphology of films formed on the glass substrate, Grown using 0.1 M (NH₄)₂SiF₆, and 0.3 M boric acid at 50° C. for 16 hours, consisting of islands with a diameter of 10 nm to 50 nm. These islands were smaller than the wavelength of visible light and was an important factor to achieve high transmittance in the 400 nm to 700 nm range i.e. visible light. SEM indicated that the film grows by island mode. AFM revealed that the films were very smooth with root mean square roughness, Vᵣₘₛ, of 6.2 nm.

### Example 2

### Optical Properties

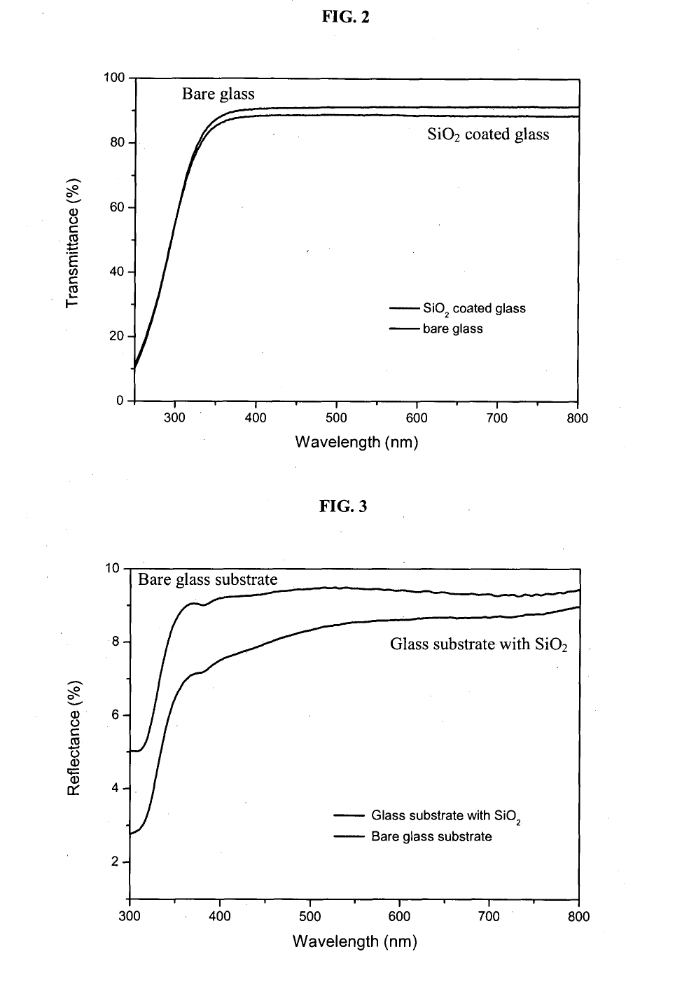

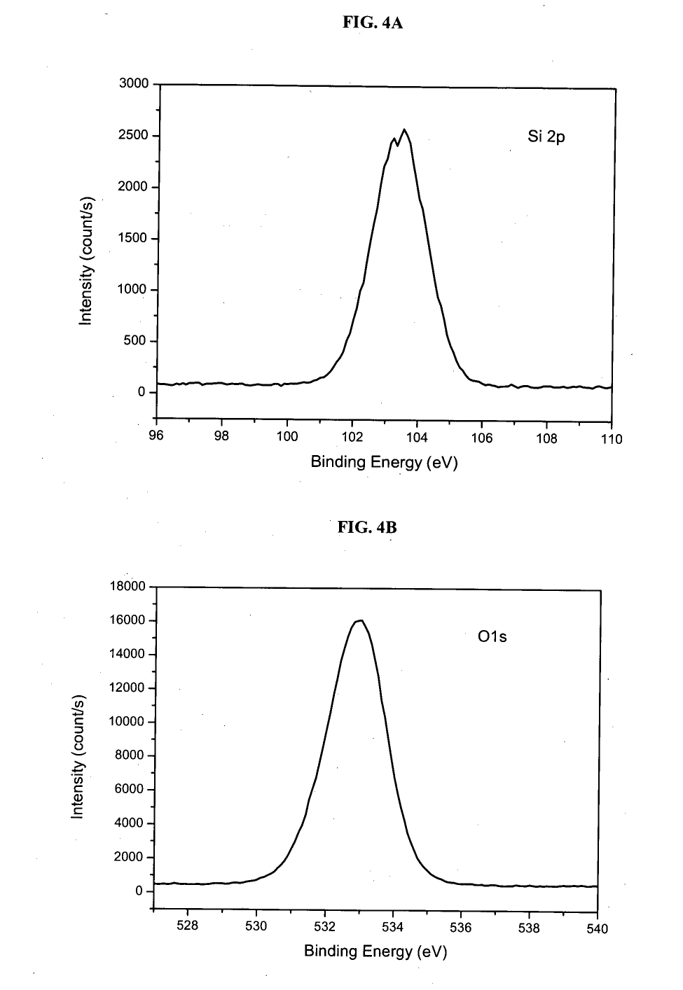

FIG. 2 shows the transmittance of films grown at 50° C. for 16 hrs compared with an uncoated glass substrate. The transmittance of the bare glass substrate was about 91% in the wavelength range of 350 nm to 800 nm. The transparency of SiO₂ coated glass was almost the same as the glass substrate with a transmittance about 85% to 89% in the wavelength range of 300 nm to 800 nm. All the films remained high level of 85% to 89%, indicating that the transmission level of glass slide was unaffected by the coated SiO₂ films. Results demonstrated that film has high transparency in visible range. The reflectance spectra of SiO₂ coated glass substrate in the visible range is shown in FIG. 3. Bare glass substrate was also measured as a comparison. Glass substrate with and without SiO₂ coating showed similar reflectance in the range of 7% to 9%, where reflectivity of coated glass is lower than uncoated glass, indicating absence of any glare problems.

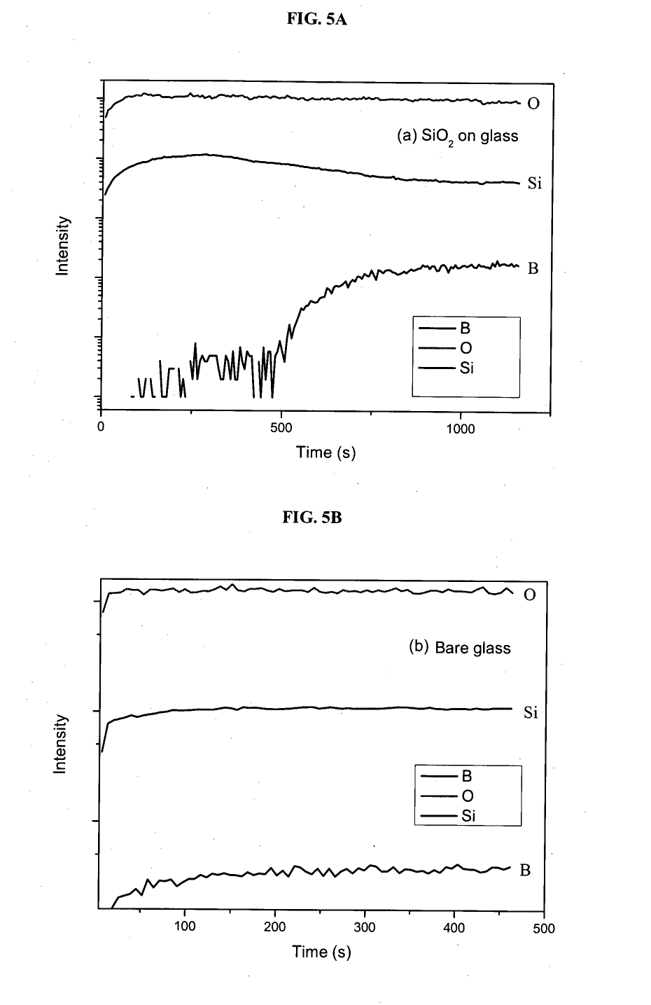

X-ray photoelectron spectroscopy (XPS) was employed to reveal the elemental composition of the SiO₂ film (FIGS. 4A and 4B). The binding energy peaks observed corresponded to the Si 2p, O 1 s electron orbitals. Quantitative analysis of the elements present in the film was performed by measuring the area under the peak divided by its atomic sensitivity factor. The XPS results showed that the SiO₂ contained not only Si and O elements but also F element which was due to the residual element from the precursor solution. The LPD SiO₂ film had a Si/O ratio of 0.524, close to the 0.529 measured for the substrate. The fluorine content was less than 0.2% for the film and less than 0.1% for the bare glass substrate.

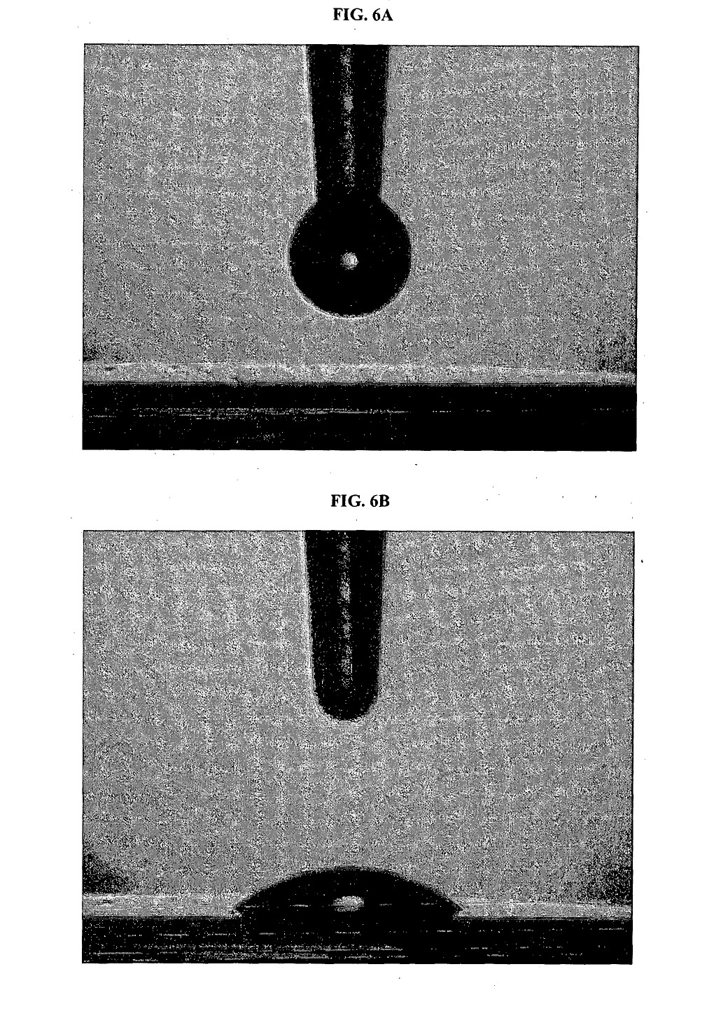

Depth profiles of chemical compositions in the SiO₂ film and bare glass substrate are shown in FIGS. 5A and 5B. Boron from the borosilicate glass substrate was very low in the film and sharply increased at the interface between the SiO₂ film grown by LPD and the glass substrate. The Si content increased from the surface and slowly decreased to the interface. In contrast, the Si content was observed fairly constant throughout the bare glass substrate (without SiO₂ film grown).

From the previous XPS results, the Si and O contents of SiO₂ films were quite similar to that of bare glass substrate. Therefore, the increase in Si content of SiO₂ film from TOF-SIMS results is due to its mesoporous structure which would lead to a higher effective sputter rate than glass substrate during the SIMS characterization. This is a good indication that the SiO₂ film disclosed herein possessed mesoporous structure which was responsible for the superhydrophilicity of the film. The mesoporous structure of the film renders it less dense, leading to a higher effective sputter rate and higher intensity.

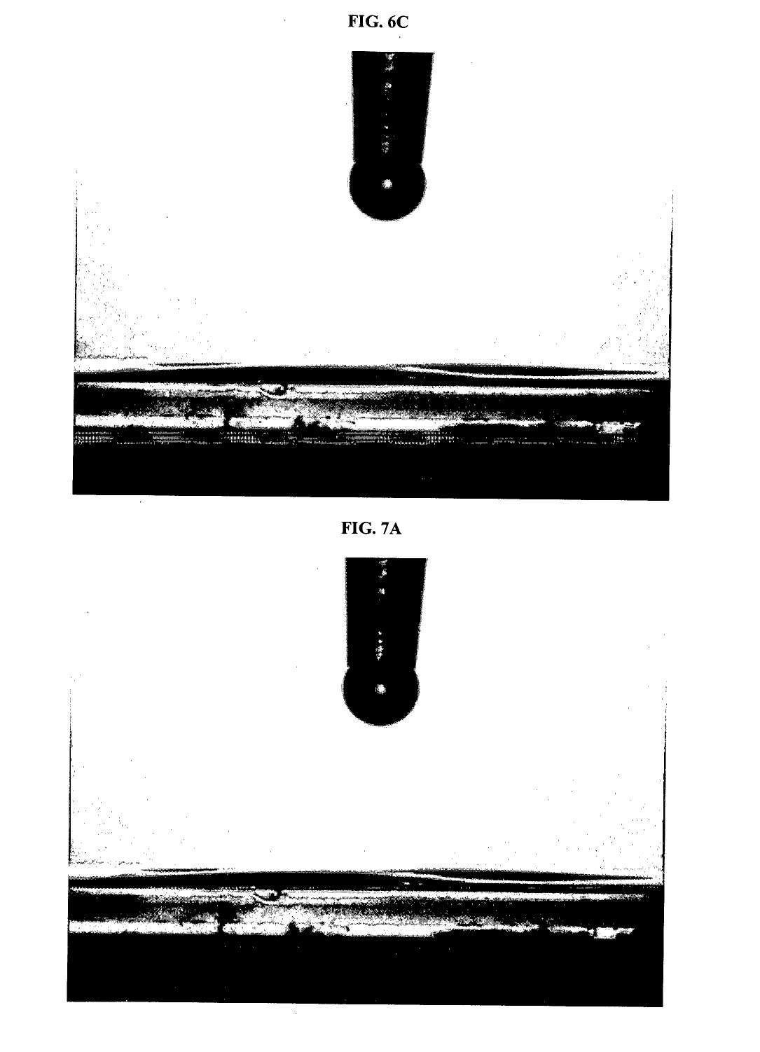

The hydrophilic property of the film was evaluated by examining the contact angle of water. The initial spreading of a water droplet on glass coated with the as-grown film and on untreated glass is shown in FIG. 6. Water droplets were gently deposited onto the surfaces using a micro-liter pipette and a charge coupled device camera lens array system was used in order to capture the image of the droplet profiles. The water droplet had a volume of 2 μL. With enhanced spreading, the water droplet penetrated into the recessed area and spread within milliseconds on the as-grown film surface. As a consequence, the film exhibited nearly zero contact angle, whereas the contact angle for water droplet on untreated glass substrate is approximately 34°. UV irradiation was not applied to activate this superhydrophilic behavior.

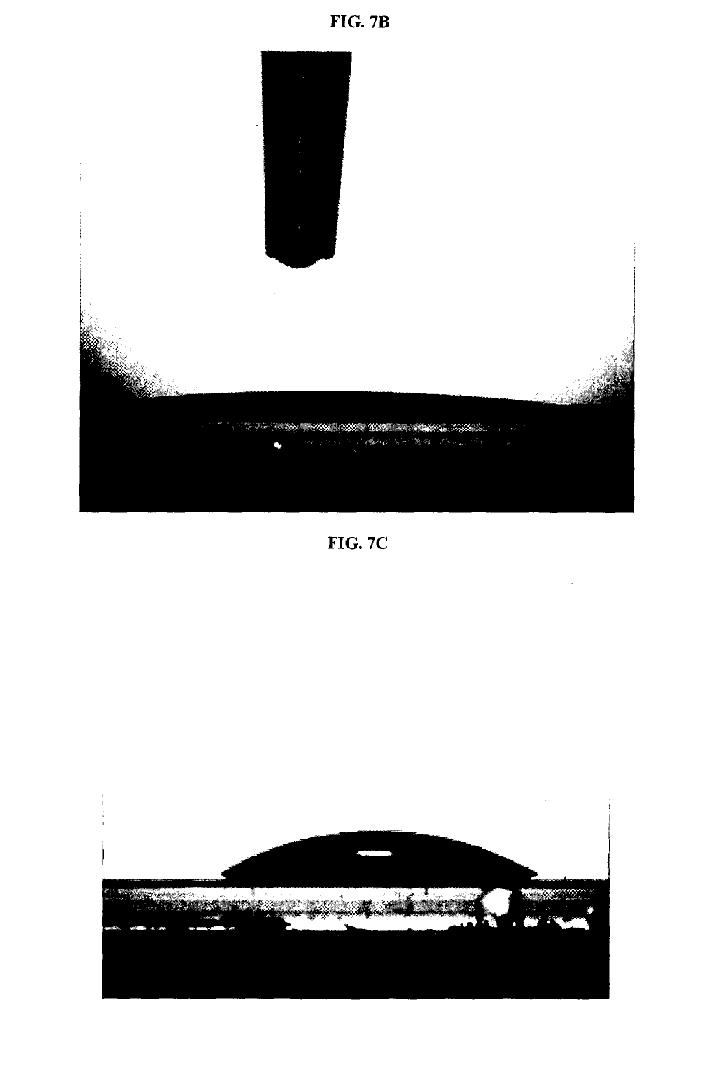

To check the persistence of superhydrophilic property of SiO₂ films, they were exposed to air for long times and the angle contact measurement was performed during the time. The contact angle of a water droplet on the coated glass coated was shown in FIG. 7A to C as a function of elapsed time (after one week, one month and more than two months). The water droplet, having a volume of 2 μL, still spread within milliseconds on the film's surface even after 2 months. As a result, the SiO₂ films still maintained their hydrophilic property. During these measurements, the UV irradiation was not applied for the activation of this superhydrophilic behavior. The SiO₂ films grown at 50° C., however, did not retain its superhydrophilicity for more than 1 month (see TABLE 1) due to the adsorption of organic pollutants on surface of the films from the air.

TABLE 1
Variation of contact angle with time for SiO₂ film grown.

| Contact angle (deg) | |
|---|---|
| Date | |
| 17 Sep. 2012 | less than 5 deg |
| | (freshly grown sample) |
| 24 Sep. 2012 | less than 5 deg |
| 1 Oct. 2012 | less than 5 deg |
| 15 Oct. 2012 (1 month) | 9.55 |
| 29 Oct. 2012 | 12.3 |
| 15 Nov. 2012 (2 months) | 28.5 |
| 3 Dec. 2012 | 32 |

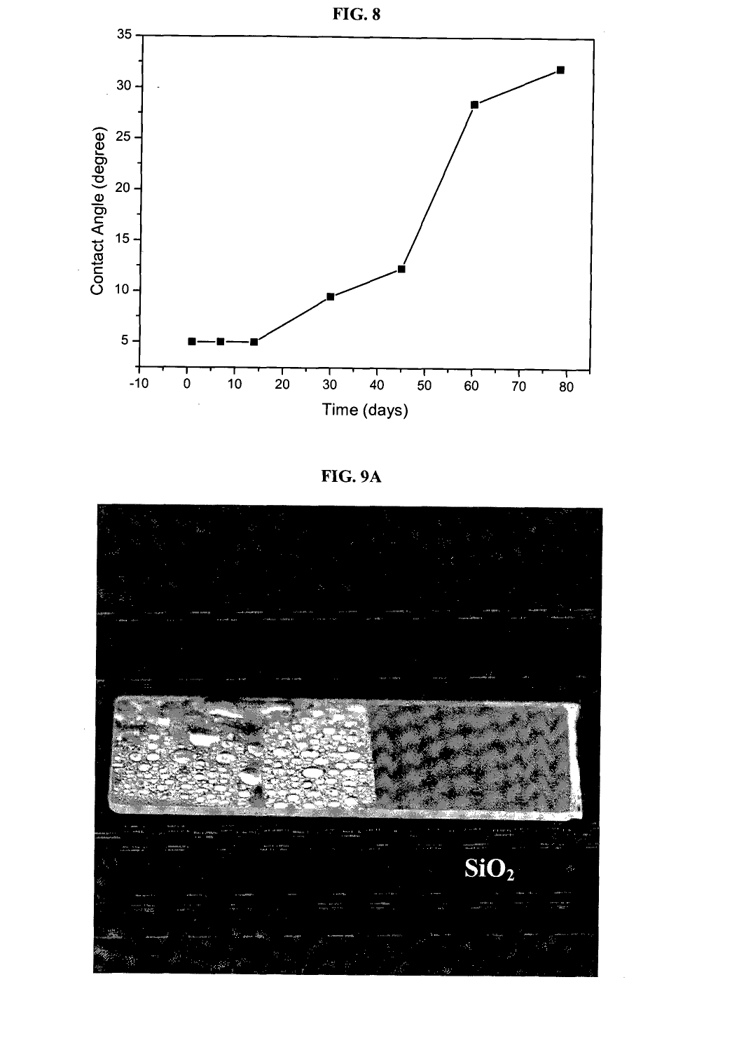

FIG. 8 is a graph showing variation of contact angle with time for SiO₂ film grown using LPD.

### Example 3

### Superhydrophilicity

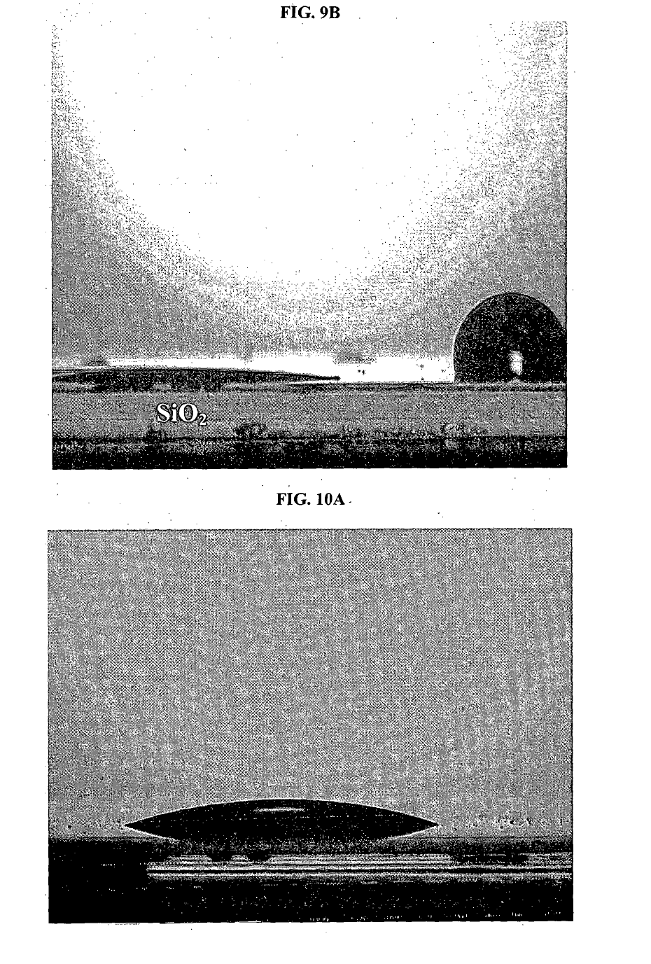

FIGS. 9A and B illustrate the water spreading behavior of SiO₂ coated glass slide using 2 μL water droplet as demonstration. One half of the glass slide was covered with thermal tape before putting into the growth solution to prevent film growth on that half. After growth, the coated glass slide was sprayed with water to simulate rain as shown in FIG. 9A. The coated part of the slide remained transparent while the uncoated part showed a lot of water droplets. This is consistent with the contact angle measurement results (FIG. 9B) of the SiO₂ coated glass slide which showed very low contact angle value (less than 10°) for the part covered with SiO₂ film and high value for the part with bare glass (FIG. 9B). With efficient superhydrophilicity, the transparent SiO₂ films offer great potential in the applications for anti-fogging and self-cleaning products.

### Example 4

### Cleaning of SiO₂ Films

### Example 4.1

### Cleaning with Water

Experiments carried out demonstrated that simple cleaning with water can bring the contact angle down again.

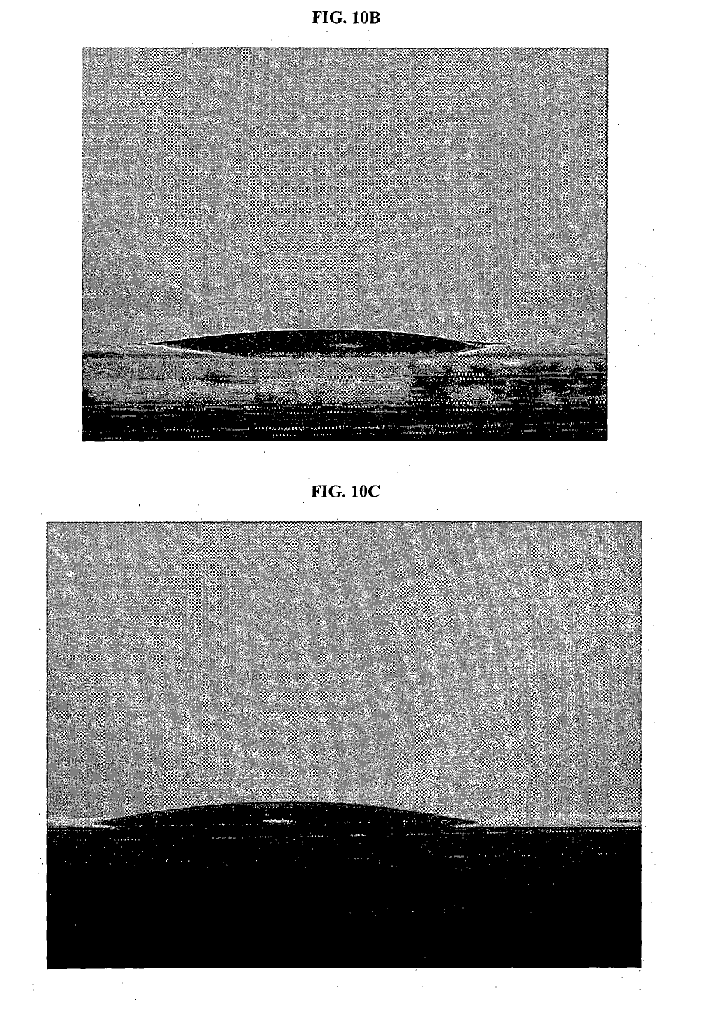

In FIG. 10A, contact angle after two months is 25°. Upon water cleaning, contact angle decreased to 17° as shown in FIG. 10B. When ultrasound cleaning in water is used, contact angle decreased to 13° as shown in FIG. 10C.

### Example 4.2

### Cleaning with Other Reagents

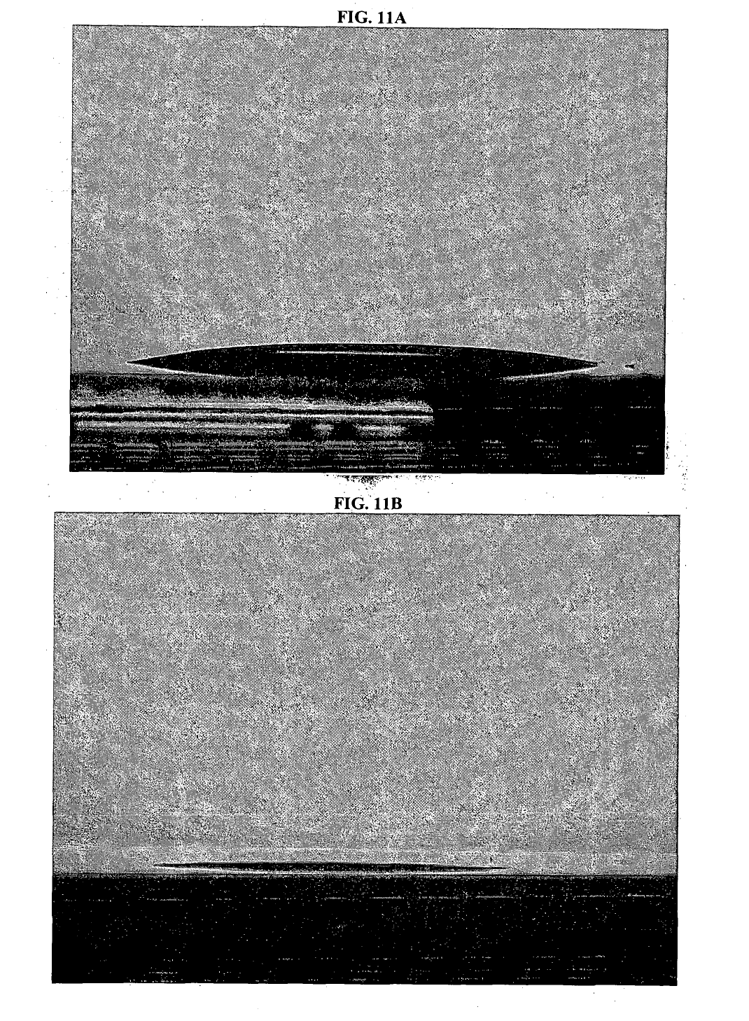

FIGS. 11A and B show effects of cleaning on contact angle of water droplet on SiO₂ film, using (A) detergent, and (B) Piranha solution.

Contact angle may be reduced after cleaning with detergent, which decreased to 15°.

Reduction of contact angle to 5° after cleaning with Piranha solution (3H₂SO₄:1 H₂O₂) illustrates that the previous cleaning methods improve wetting due to removal of surface organic species.

A simple and reproducible way to deposit SiO₂ films for self-cleaning, anti-fogging applications has been demonstrated. The solution-based route may be easily applied to large-scale production of the film. Moreover, the LPD in this approach is completed at 50° C. and lower, which is a significant step as growth below the boiling point of water means that pressure containing autoclaves are no longer needed for growth. It also introduces possibility of in-situ growth monitoring by optical techniques since glass, instead of stainless steel reactors, may be used. The low temperature LPD process has great potential in depositing SiO₂ films on temperature-sensitive substrates like plastics and glasses.

Transparent SiO₂ films were successfully prepared with high adhesion at low temperature by using liquid phase deposition method. Transmittance of film on glass substrate was 85% or more in the wavelength region from 350 nm to 800 nm. This is important especially if such coatings can be optimized to be superhydrophilic. A major novelty here is the use of precursors by the LPD method to form a mesoporous SiO₂ film with persistent superhydrophilic property on glass substrate at low temperature, which has not been previously reported.

As demonstrated herein, contact angle measurements of as-prepared SiO₂ films prepared by LPD reveal very small water contact angles (<10°) indicating that superhydrophilicity may be obtained without any application of UV light. This is important since self-cleaning SiO₂ may be used indoors or where there is weak UV illumination. Superhydrophilic property may be attributed to the mesoporous structure of the film.

Application areas include anti-fog lens such as spectacle and camera lens, antifouling coatings, self-cleaning surfaces, mirrors, such as car side view mirrors, windshields, and windows. One of more of the above application areas may provide for improved visibility under bad weather conditions such as in the rain, for example.

According to embodiments, methods of forming a superhydrophilic SiO₂ coating are provided. In the embodiments shown, deposition temperatures of less than 100° C. are used and no UV excitation is applied. The superhydrophilic coating thus formed on glass substrates has high transmittance of at least 85% in the wavelength region from 350 nm to 750 nm. Chemical precursors used include ammonium hexafluorosilicate and boric acid. Solutions made with such chemicals should have concentrations less than 0.1 M and 0.3 M, respectively. In specific embodiments, growth temperatures are less than 80° C. so as to achieve high transparency of the coatings.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a superhydrophilic coating consisting essentially of silicon oxide wherein trace amounts of other substances present in the superhydrophilic coating is less than 0.5 atomic %, the method comprising
a) providing an aqueous mixture comprising a fluorine-containing silicon complex and a fluorine scavenger; and
b) contacting a substrate with the aqueous mixture at a temperature of less than about 100° C. to obtain said superhydrophilic coating on the substrate.

2. The method according to claim 1, wherein the fluorine-containing silicon complex has general formula (I):
A2SiF6 (I)
wherein A is selected from the group consisting of hydrogen, alkali metal, ammonium group, and coordinated water.

3. The method according to claim 1, wherein the fluorine-containing silicon complex comprises or consists of (NH4)2SiF6.

4. The method according to claim 1, wherein concentration of fluorine-containing silicon complex in the aqueous mixture is in the range of about 0.02 M to about 0.1 M.

5. The method according to claim 1, wherein the fluorine scavenger is selected from the group consisting of boric acid, alkali metal borate, ammonium borate, boron anhydride, boron monoxide, aluminum chloride, sodium hydroxide, aqueous ammonia, metallic aluminum, aluminum oxide, and combinations thereof.

6. The method according to claim 1, wherein the fluorine scavenger comprises or consists of boric acid.

7. The method according to claim 5, wherein concentration of fluorine scavenger in the aqueous mixture is in the range of about 0.06 M to about 0.3 M.

8. The method according to claim 1, wherein the substrate is a glass substrate.

9. The method according to claim 1, wherein contacting a substrate with the aqueous mixture is carried out at a temperature in the range of about 50° C. to about 80° C.

10. The method according to claim 1, wherein contacting a substrate with the aqueous mixture is carried out for a time period in the range of about 2 hours to about 72 hours.

11. The method according to claim 1, wherein UV excitation is not used to activate superhydrophilicity of the superhydrophilic coating.

12. The method according to claim 1, wherein the superhydrophilic coating consists essentially of islands of silicon dioxide.

13. The method according to claim 12, wherein each of the silicon dioxide islands have a size in the range of about 10 nm to about 50 nm

14. The method according to claim 1, wherein the superhydrophilic coating is mesoporous.

15. The method according to claim 1, wherein the superhydrophilic coating exhibits a transmittance of at least 85% in the wavelength region from 350 nm to 750 nm.

16-20. (canceled)
